(19) United States
(12) Patent Application Publication
(10) Pub. No.: US 2018/0320415 A1
(43) Pub. Date: Nov. 8, 2018

(54) FENCE GATE LATCH ASSEMBLY

(71) Applicant: Yao-Kun Yang, CHANGHUA COUNTY (TW)

(72) Inventor: Yao-Kun Yang, CHANGHUA COUNTY (TW)

(21) Appl. No.: 15/588,724

(22) Filed: May 8, 2017

(51) Int. Cl. E05B 65/00; E05C 19/12; E05B 53/00

(52) U.S. Cl. CPC E05B 65/0007; E05B 53/003; E05C 19/12

(57) ABSTRACT

A latch assembly includes a lock and a fixed part respectively located on outside and inside of the gate post. The lock includes a cover that is controlled by the users. A catch part is pivotably located in the slot of the fixed part by a pin. The catch part has an extension which extends beyond the slot. A cable extends through the gate post and is connected between the extension of the catch part and the cover of the lock. A torsion spring is mounted to the pin and engaged with the catch part. A latch is connected to a gate and movably enters the opening to be engaged with the recess of the catch part. When unlocking the lock and pivoting the cover, the cable pivots the catch part to allow the latch to be disengaged from the catch part.

### BACKGROUND OF THE INVENTION

### 1. Fields of the Invention

The present invention relates to a latch assembly, and more particularly, to a fence gate latch assembly cooperated with a lock on the outside of the fence gate to control the opening of the latch assembly.

### 2. Descriptions of Related Art

One of the conventional latch assembly for the fence gate is disclosed in FIG. 12 and comprises a first part 8 and a second part 9, wherein the first part 8 is connected to the gate post and the second part 9 is connected to the gate. A bolt latch is located at the second part 9 and can be operated to be inserted into a tubular receiving member on the first part 8 to maintain the gate at closed position. The bolt latch includes a lever and the users may pull the lever to remove the bolt latch out from the receiving member to open the gate. However, the latch assembly mentioned above can be easily accessed by any unauthorized person and the gate is opened without permission. Some users install a door lock to the gate and the door lock requires a key to unlock it. Nevertheless, once the key is lost, the lock cannot be unlocked and this may cause problem to the users.

The present invention intends to provide a latch assembly for a fence gate which is cooperated with a lock on the outside of the gate, the users input correct combination to unlock the lock and then operate the latch assembly to open the gate.

### SUMMARY OF THE INVENTION

The present invention relates to a latch assembly and comprises a lock having a base and a cover which is pivotably opened or closed relative to the base. The base is fixed to outside of the gate post. The cover includes at least one locking piece on the inside thereof which faces the base.

A fixed part has a slot defined through the top and the bottom thereof. An opening is defined in the front side of the fixed part. The fixed part is fixed to the inside of the gate post. A catch part is pivotably located in the slot by a pin, and has a recess defined in the lower end thereof. An extension extends from the catch part and extends beyond the slot. A cable extends through the gate post and has a first end connected to extension, and a second end of the cable is connected to the at least one locking piece. The catch part is pivotable about the pin. A torsion spring is mounted to the pin, and an end of the torsion spring is engaged with the catch part. Two legs of the torsion spring are positioned at two respective insides of the slot. A latch is connected to the gate and movably enters into the opening and is with the recess of the catch part to close the gate.

Preferably, the catch part has a hook end which forms the recess. The extension has a hole and the first end of the cable is secured to the hole.

Preferably, the torsion spring includes two loop portions, an engaging portion which is connected to the two loop portions, and two legs respectively extending from the two loop portions. The catch part has a notch defined in the top thereof and the engaging is engaged with the notch. A stud extends from each of the two insides of the slot. The studs each are an L-shaped stud, and the two legs are hooked to the two studs.

Preferably, a protection member is connected to the gate post 20 and located above the fixed part. The fixed part is covered by the protection member.

Preferably, the latch includes a fixed portion and a bar. The fixed portion is fixed to the gate. The bar extends from the fixed portion and is engaged with the recess or disengaged from the recess.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the fixed part and the catch part of the latch assembly of the present invention;

FIG. 2 is a rear end view to show the combination of the fixed part and the catch part of the latch assembly of the present invention;

FIG. 3 shows that the torsion spring is cooperated with the catch part of the latch assembly of the present invention;

FIG. 4 is an exploded view of the fixed part, the torsion spring and the catch part of the latch assembly of the present invention;

FIG. 5 shows that the combination of the fixed part and the catch part of the latch assembly of the present invention is to be connected to the gate post;

FIG. 6 shows that a protection member is to be connected to the gate post to cover the combination of the fixed part and the catch part of the latch assembly of the present invention;

FIG. 7 shows that the bar is engaged with the recess of the catch member when the gate is closed;

FIG. 8 shows that the cover of the lock is pulled downward to pull the cable;

FIG. 9 is a cross sectional view to show the latch assembly of the present invention installed to the gate post;

FIG. 10 is a cross sectional view, taken along line X-X in FIG. 8;

FIG. 11 is a cross sectional view to show that the cover of the lock is pulled downward to pull the cable, and the catch part is pivoted upward;

FIG. 12 shows a conventional bolt latch.

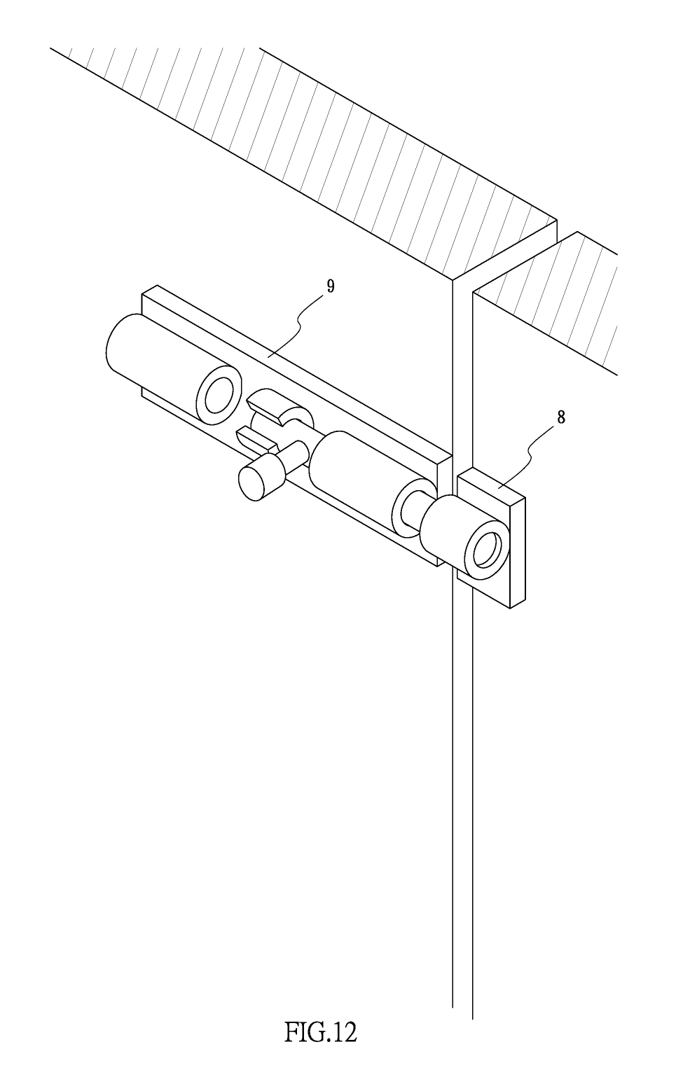

### DETAILED DESCRIPTION OF THE PREFERRED EMBODIMENT

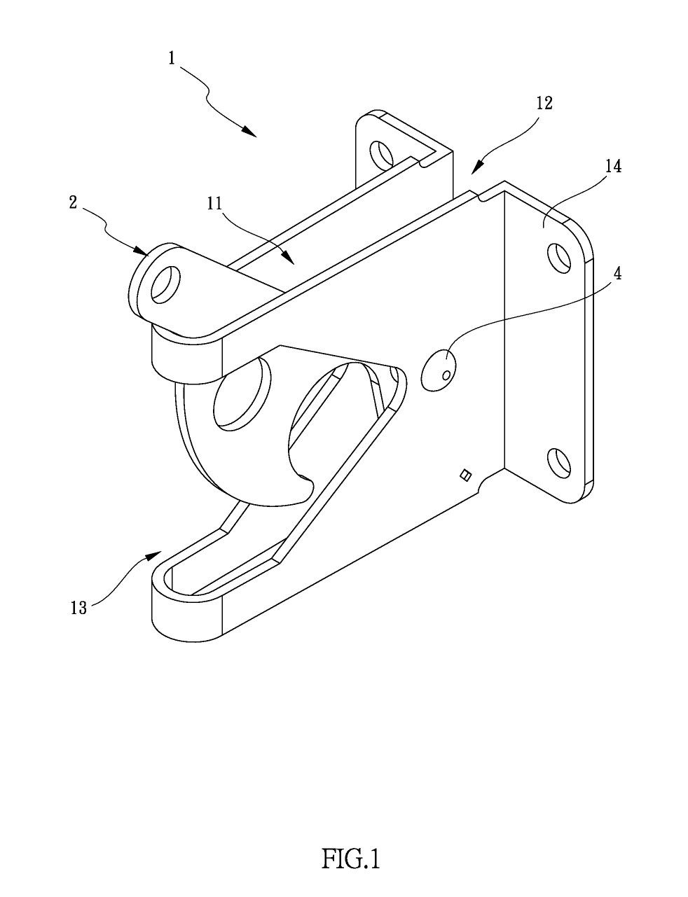

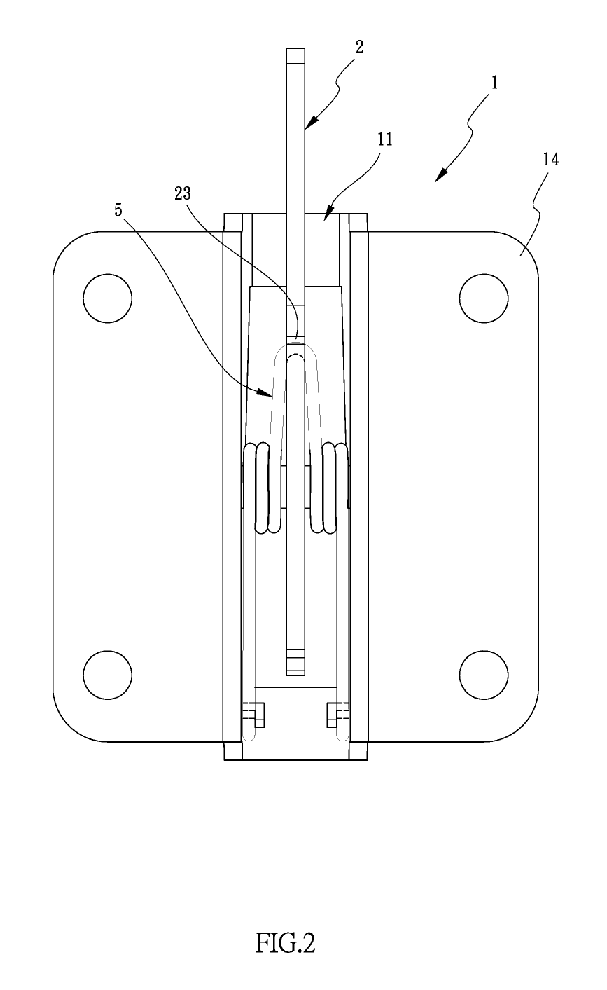

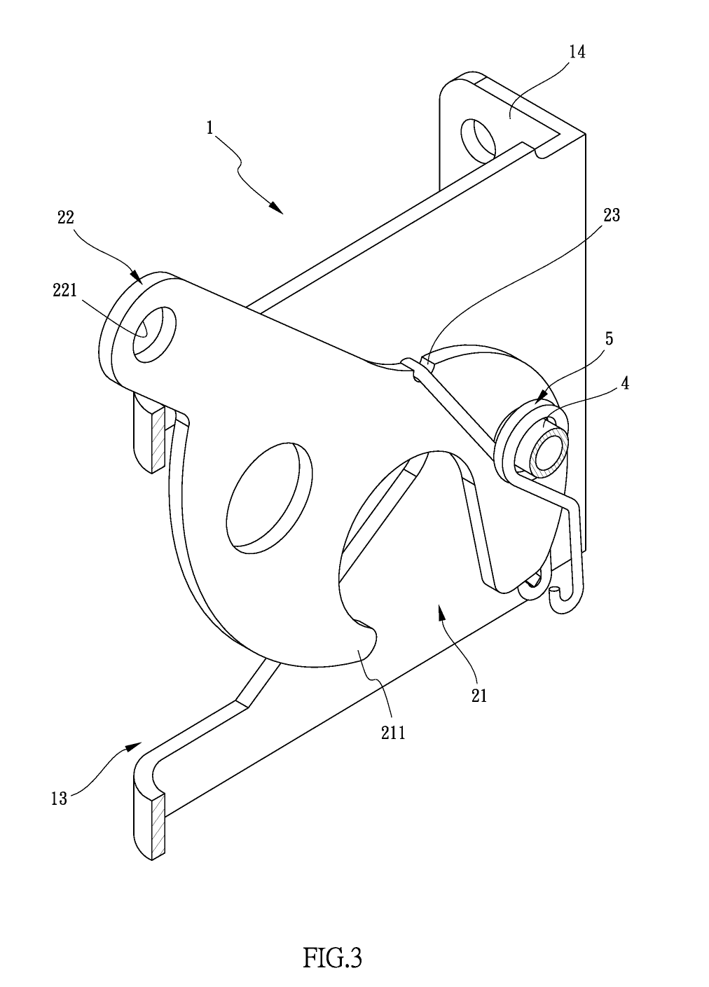

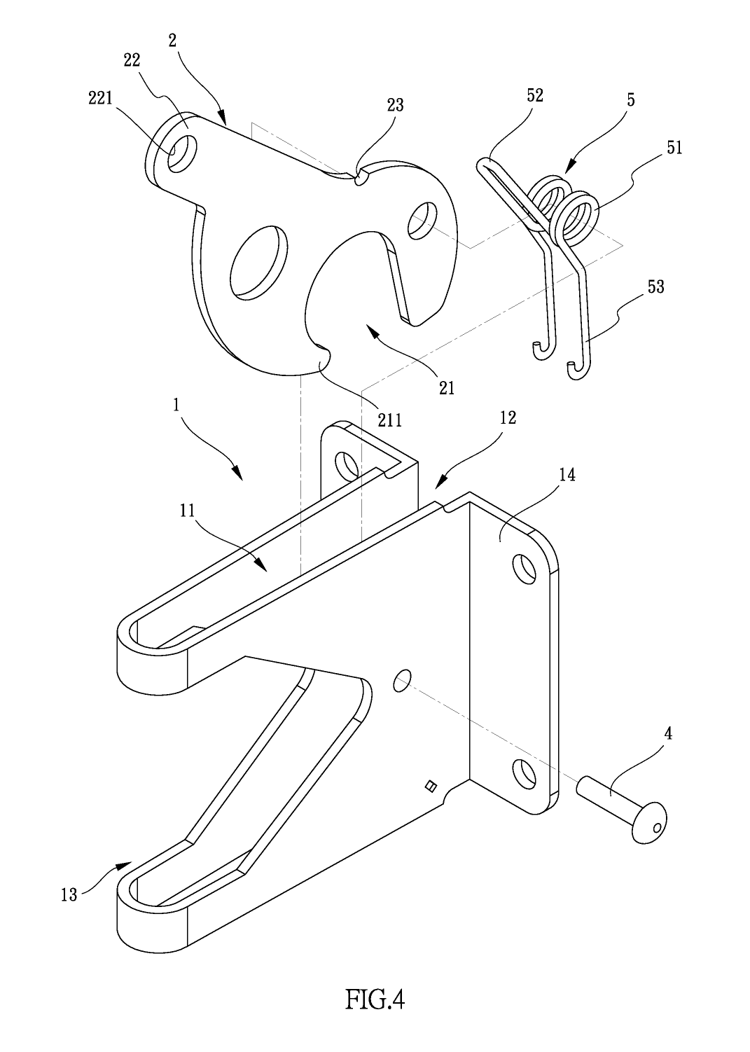

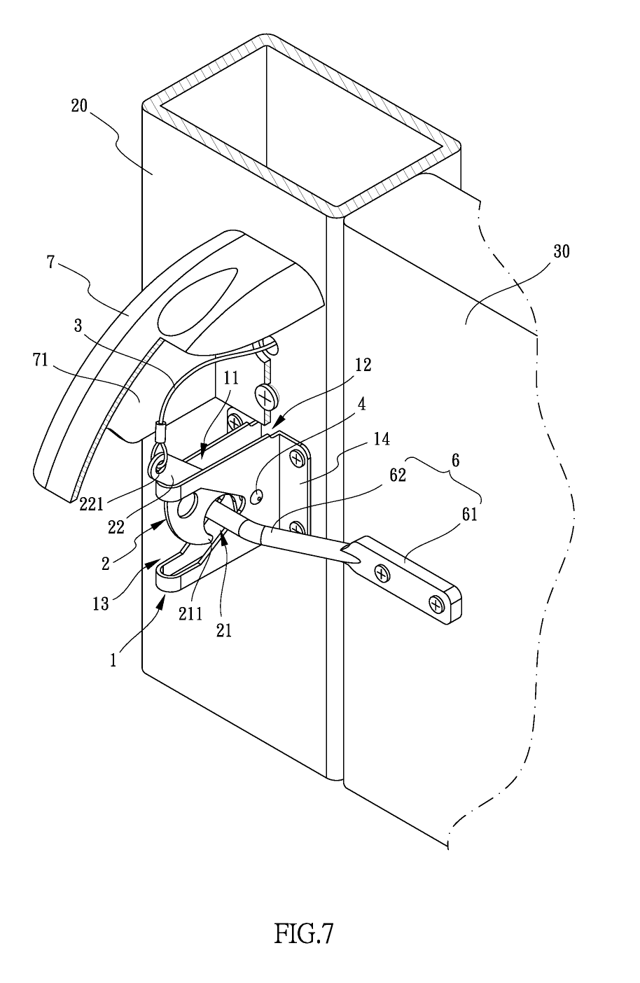

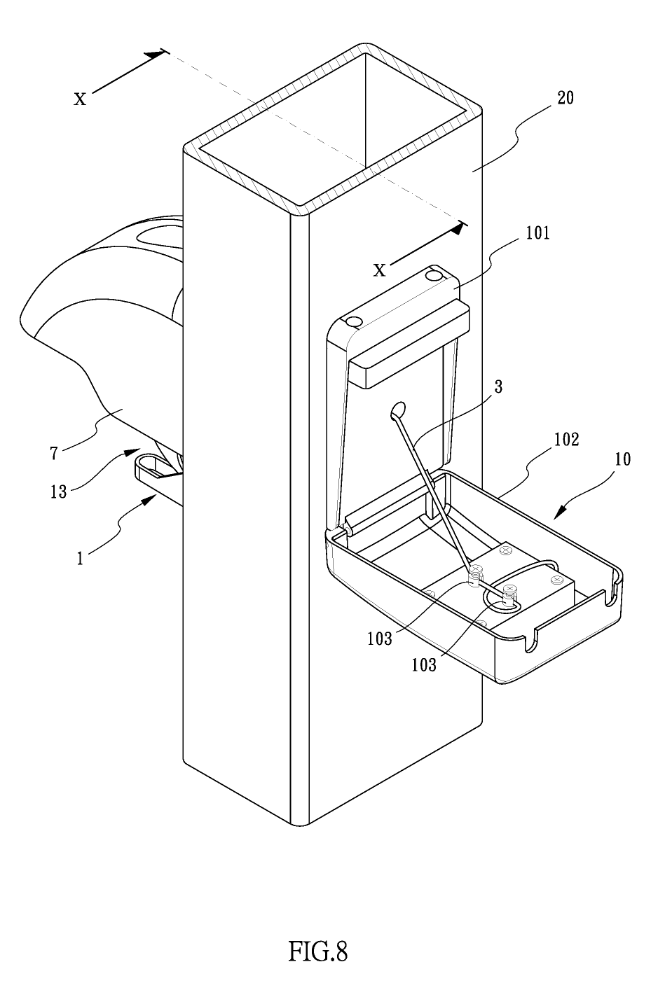

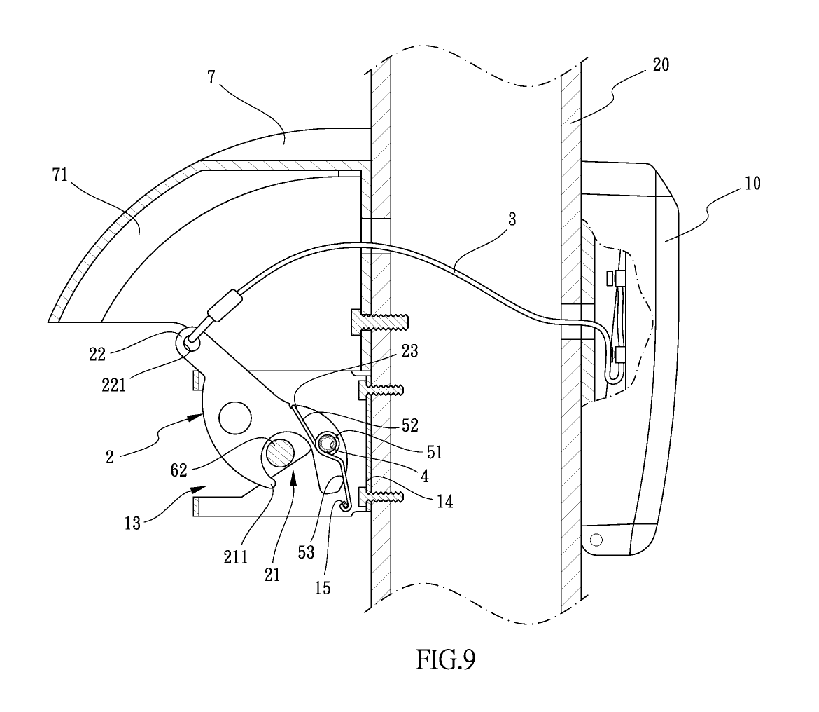

Referring to FIGS. 1 to 11, the latch assembly of the present invention comprises a lock 10 which is a combination lock and includes a base 101 and a cover 102 which is pivotably opened or closed relative to the base 101. The base 101 is fixed to outside of a gate post 20 as shown in FIG. 8. The cover 102 includes two locking pieces 103 on the inside thereof which faces the base 101.

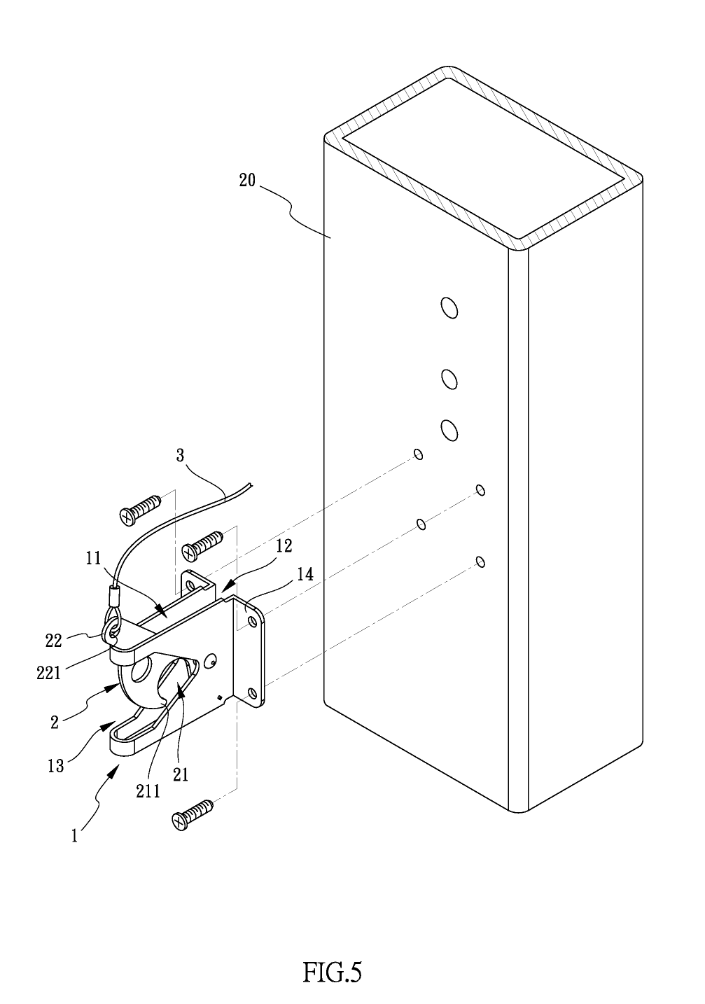

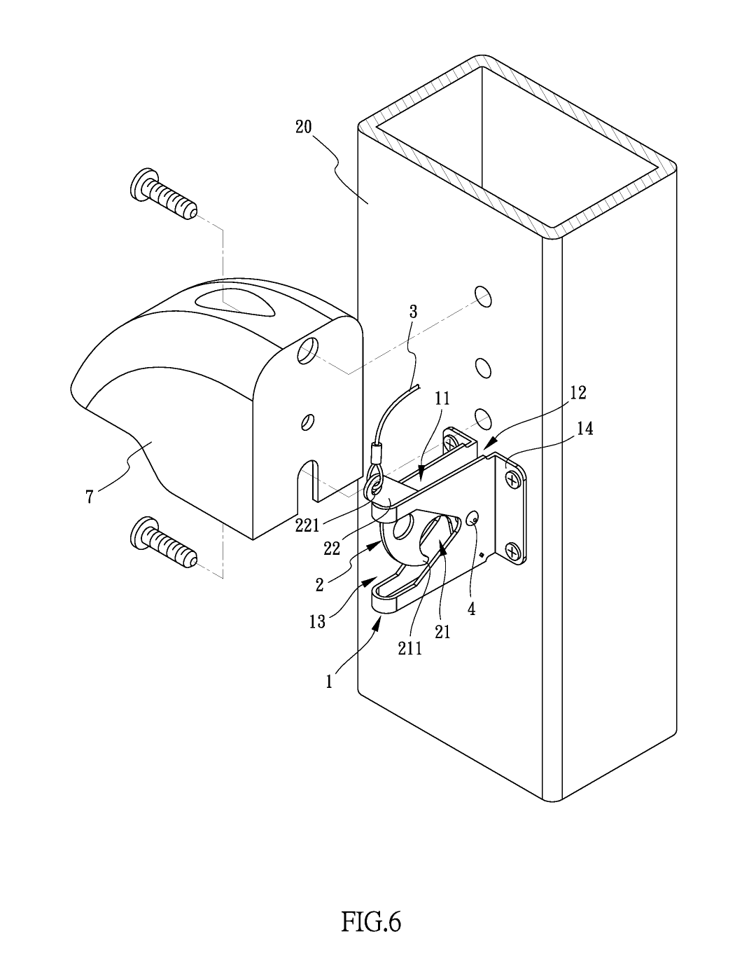

A fixed part 1 has a slot 11 defined through the top and the bottom thereof. An entrance 12 is defined in the rear side of the fixed part 1, and an opening 13 is defined in the front side of the fixed part 1. The slot 11 communicates with the entrance 12 and the opening 13. Two wings 14 extend perpendicularly from two sides of the rear side of the fixed part 1, and the two wings 14 are fixed to the inside of the gate post 20 as shown in FIGS. 5 and 6.

A catch part 2 is pivotably located in the slot 11 by extending a pin 4 through the fixed part 1 and the catch part 2, so that the catch part 2 is pivotable about the pin 4. The catch part 2 has a recess 21 defined in the lower end thereof. An extension 22 extends from the catch part and extends beyond the slot 11. The catch part 2 has a hook end 211 which forms the recess 21. The hook end 211 is a rounded end and extends toward the toward the rear side of the fixed part 1. The catch part 2 has a curved portion formed on the front side thereof so as to guide the latch 6 to be engaged with the recess 21, and the latch 6 will be described later. The extension 22 has a hole 221.

A cable 3 extends through the gate post 20 and has a first end thereof secured to the hole 221, and a second end of the cable 3 is connected to the locking pieces 103. A torsion spring 5 mounted to the pin 4 and includes two loop portions 51, an engaging portion 52 which is connected to the two loop portions 51, and two legs 53 respectively extending from the two loop portions 51. The pin 4 extends through the two loops 51. The catch part 2 has a notch 23 defined in the top thereof and the engaging 52 is engaged with the notch 23. A stud 15 extends from each of the two insides of the slot 11, wherein the studs 15 each are an L-shaped stud. The two legs 53 each have a hooked end which is hooked to the stud 15 corresponding thereto.

The latch 6 is connected to a gate 30 and movably enters into the opening 13 and is engaged with the recess 21 of the catch part 2 to maintain the gate 30 at the closed position.

A protection member 7 is connected to the inside of the gate post 20 and located above the fixed part 1. The protection member 7 includes an inverted U-shaped cross section so that the fixed part 1 is partially accommodated in the room 71 of the protection member 7. The protection member 7 protects the fixed part 1 and the catch part 2 from being exposed under sun and rain. The latch 6 includes a fixed portion 61 and a bar 62, wherein the fixed portion 61 is fixed to the gate 30. The bar 62 extends from the fixed portion 61 and is engaged with the recess 21 or disengaged from the recess 21.

When the users want to leave from the house, the catch part 2 is pivoted upward by either pushing the extension 22 or pulling the cable 3 to remove the catch part 2 away from the latch 6, the gate 30 can be opened.

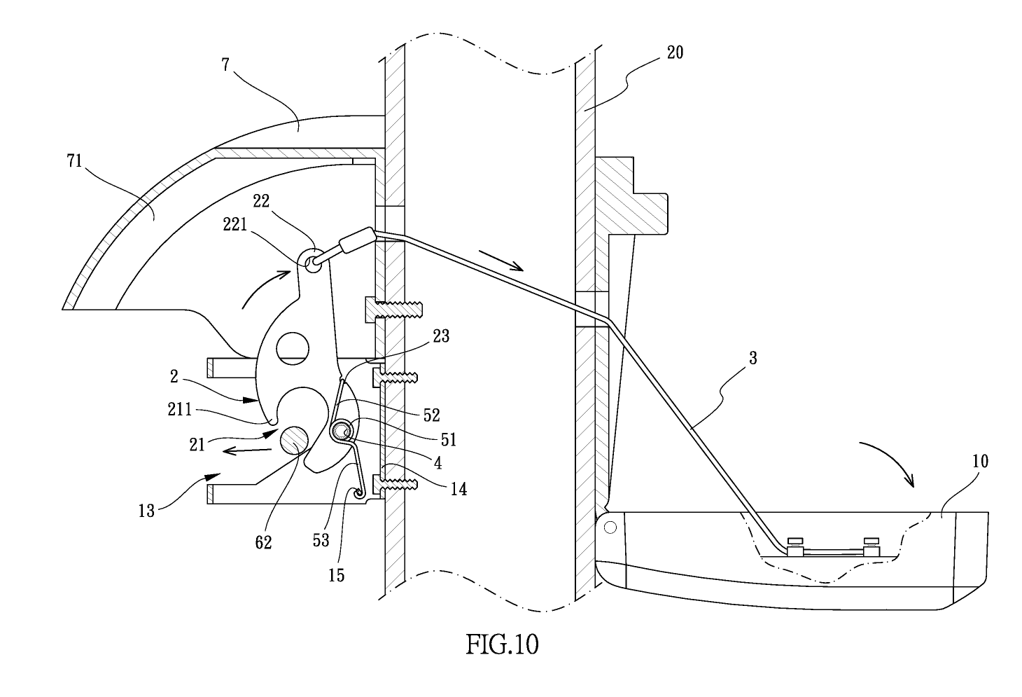

When the users come back to the house, a correct combination is input to unlock the lock 10, the cover 102 is then pivoted downward as shown in FIGS. 8 and 10, the cable 3 is pulled by the movement of the cover 102 such that the catch part 2 is pivoted upward to release the latch 6. The gate 30 can be opened.

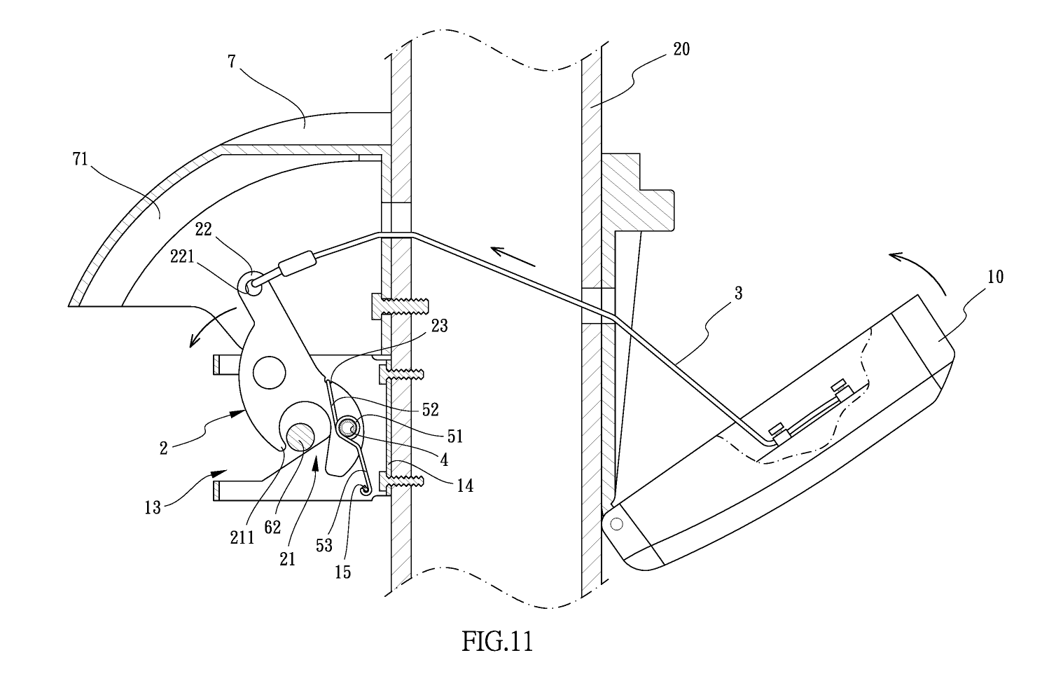

As shown in FIG. 11, when the cover 102 is released, the torsion spring 5 pivots the catch part 2 downward, and when the gate 30 is pivoted toward the gate post 20, the latch 6 is guided by the curved portion formed on the front side of the catch part 2 such that the latch 6 pushes the catch part 2 to pivot upward until the latch 6 is engaged with the recess 21 to maintain the gate 30 at the closed position.

While we have shown and described the embodiment in accordance with the present invention, it should be clear to those skilled in the art that further embodiments may be made without departing from the scope of the present invention.

What is claimed is:

1. A latch assembly comprising:
a lock having a base and a cover which is pivotably opened or closed relative to the base, the base adapted to be fixed to outside of a gate post, the cover including at least one locking piece on an inside thereof which faces the base;
a fixed part having a slot defined through a top and a bottom thereof, an entrance defined in a rear side of the fixed part, and an opening defined in a front side of the fixed part, the slot communicating with the entrance and the opening, two wings extending perpendicularly from two sides of the rear side of the fixed part, the two wings adapted to be fixed to an inside of the gate post;
a catch part pivotably located in the slot and having a recess defined in a lower end thereof, an extension extending from the catch part and extending beyond the slot, a cable adapted to extend through the gate post and having a first end connected to extension, and a second end of the cable connected to the at least one locking piece;
a pin extending through the fixed part and the catch part, the catch part being pivotable about the pin, a torsion spring mounted to the pin, and an end of the torsion spring engaged with the catch part, two legs of the torsion spring positioned at two respective insides of the slot, and
a latch adapted to be connected to a gate and movably entering into the opening and being engaged with the recess of the catch part.

2. The latch assembly as claimed in claim 1, wherein the catch part has a hook end which forms the recess, the extension has a hole and the first end of the cable is secured to the hole.

3. The latch assembly as claimed in claim 1, wherein the torsion spring includes two loop portions, an engaging portion which is connected to the two loop portions, and two legs respectively extending from the two loop portions, the catch part has a notch defined in a top thereof and the engaging is engaged with the notch, a stud extends from each of the two insides of the slot, the studs each are an L-shaped stud, the two legs are hooked to the two studs.

4. The latch assembly as claimed in claim 2, wherein the torsion spring includes two loop portions, an engaging portion which is connected to the two loop portions, and two legs respectively extending from the two loop portions, the catch part has a notch defined in a top thereof and the engaging is engaged with the notch, a stud extends from each of the two insides of the slot, the studs each are an L-shaped stud, the two legs are hooked to the two studs.

5. The latch assembly as claimed in claim 1, wherein a protection member is adapted to be connected to the gate post and located above the fixed part, the fixed part is accommodated in a room of the protection member.

6. The latch assembly as claimed in claim 1, wherein the latch includes a fixed portion and a bar, the fixed portion is adapted to be fixed to the gate, the bar extends from the fixed portion and is engaged with the recess or disengaged from the recess.
